(19) United States
(12) Patent Application Publication
(10) Pub. No.: US 2019/0294417 A1
(43) Pub. Date: Sep. 26, 2019

(54) METHOD AND SYSTEM FOR DERIVING DETERMINISTIC PRIME NUMBER

(71) Applicant: Huawei International Pte. Ltd., Singapore (SG)

(72) Inventors: Shuang WU, Singapore (SG); Sampo SOVIO, Helsinki (FI); Xiaopu WANG, Beijing (CN)

(21) Appl. No.: 16/423,614

(22) Filed: May 28, 2019

Related U.S. Application Data
(63) Continuation of application No. PCT/SG2017/050345, filed on Jul. 7, 2017.

(30) Foreign Application Priority Data
Nov. 28, 2016 (SG) 10201609975T

(51) Int. Cl. G06F 7/72

(52) U.S. Cl. CPC G06F 7/72; G06F 7/582; G06F 2207/7204

(57) ABSTRACT

A system generating a prime number comprising a prime number generator (PNG) module and a pseudorandom number generator (PRNG) module which is configured to: initialise the pseudorandom number generator (PRNG) module; receive a request from the PNG module, the request containing a bit length of the pseudorandom number required; generate the required bit length of pseudorandom number; transmit a response containing the generated bit length of pseudorandom numbers to the PNG module. The PNG module is configured to: transmit the request containing the bit length of the pseudorandom numbers required; receive the response from the PRNG module; assign the pseudorandom numbers in the response to form raw data PPP; set a least significant bit (LSB) and most significant bit (MSB) of PPP as 1 to obtain a first big odd number denoted as PP; and execute an algorithm to determine a first big prime number starting from odd number PP.

### CROSS-REFERENCE TO RELATED APPLICATIONS

This application is a continuation of International Application No. PCT/SG2017/050345, filed on Jul. 7, 2017, which claims priority to Singapore Patent Application No. 10201609975T, filed on Nov. 28, 2016. The applications of the aforementioned applications are hereby incorporated by reference in their entireties.

### FIELD OF THE INVENTION

This application relates to a method and system for obtaining two prime numbers for generating a pair of keys. Particularly, the application relates to a method and system implementing a deterministic derivation function to obtain prime numbers.

### BACKGROUND

Public-key cryptography is the most important tool for secure communications on internet, especially for security of online payment.

The FIDO Alliance was formed in the summer of 2012, with PayPal, Lenovo, Nok Nok Labs, Validity Sensors, Infineon, and Agnitio as the founding companies, dedicated to working on a passwordless authentication protocol. This passwordless protocol allows easier and faster method for making payment online. The authentication procedure of this protocol consists of two parts, namely, fingerprint verification and device certificate verification, which requires that each smart phone has its own private key and certificate for its public-key. In China, a similar alliance called IFAA was founded by Ant Financial, Samsung, Huawei, ZTE, OPPO and CoolPad etc., which develops standards for fingerprint verification and device certificate verification.

The use of private key and public key enables secure transmission of data containing confidential information. There are various algorithms that use private and public keys and each algorithm may have different implementations. The most widely used asymmetric cryptographic algorithm is the one developed by Ron Rivest, Adi Shamir and Leonard Adelman (RSA). The RSA algorithm creates a pair of keys, namely, public key and private key. There are two ways of using an asymmetric key algorithm, namely, encryption and digital signature. Some algorithm can only do one of the two implementations. However, the RSA algorithm is capable of providing both implementations.

When an asymmetric-key algorithm is used for encryption, the public key is for encrypting data and the private key is used for decrypting data. Everyone can encrypt data using the public key but only the owner of the private key can decrypt the data.

When the asymmetric-key algorithm is used for digital signature, the private key is used for signing the message and the public key is used for verifying the signature. Everyone can verify the digital signature but only the owner of the private key can sign new messages.

The mathematical description of the key generation of RSA algorithm is as follows:
1. Two big prime numbers P and Q are chosen randomly such that the binary expressions of them are of the same length (For RSA-2048, the bit-sizes of P and Q are chosen as 1024 bit).
2. Compute the product of P and Q as the modulus N=PQ.
3. Compute the value of φ(N)=(P−1)(Q−1).
4. Choose the parameter e of the public key such that GCD(e,φ(N))=1, where GCD (x, y) stands for the greatest common divisor of integer x and y.
5. Find d such that ed≡1 mod φ(N). Equivalently, ed=k·φ(N)+1 for some integer k.
6. (e, N) is the public key pk and (d, N) is the private key (secret key) sk.

The mathematical description of the encryption and decryption of RSA algorithm is as follows:
1. Alice wants to send some secret information, noted as plaintext m to Bob.
2. Alice encrypts the plaintext m using Bob's public key pk_{Bob}=(e,N): c=Enc(pk_{Bob}, m)≡m^{e}mod N and send c to Bob through certain unsecured channel;
3. After receiving ciphertext c, Bob use his own private key sk_{Bob}=(d, N) to decrypt the ciphertext and get the secret information plaintext m=Dec(sk_{Bob}, c)=c^{d} mod N.
   Euler's Theorem: α^{φ(N)}≡1 mod N for all α and N such that a and N are co-prime (GCD(α,N)=1).
   According to Euler's Theorem, C^{d}≡(m^{e})^{d}≡m^{ed}≡m^{k·φ(N)+1}≡m mod N, the Dec(sk, c) function will always return the correct plaintext m.

The mathematical description of signing messages using digital signature via the RSA algorithm is as follows:
1. Bob signs a message m using his private key sk_{Bob}=(d,N): For message m, calculate the hash digest as h=Hash(m). Then calculate the signature using private key: sig=h^{d} mod N;
2. Bob publishes message together with the signature (m, sig).
3. Alice receives (m, sig) and wants to verify if the signature is from Bob.
4. Alice obtains Bob's public key pk_{Bob}=(e, N) from the Certificate Authority (CA).
5. Alice calculate the hash digest of the message as h=Hash(m) and decrypt the sig value and get h′=sig^{e} mod N.
6. Alice compares h and h′ to see if they are equal or not. If h=h′, the signature from Bob is successfully verified.

In key generation of RSA algorithm, P and Q are tested to affirm that both are prime numbers. The Miller-Rabin primality test or Rabin-Miller primality test is a primality test using an algorithm which determines whether a given number is prime, similar to the Fermat primality test and the Solovay-Strassen primality test. The original version, due to Gary L. Miller, is deterministic, but the determinism relies on the unproven Extended Riemann hypothesis, and Michael O. Rabin modified it to obtain an unconditional probabilistic algorithm. The Rabin-Miller primality test can be described as follows:

Step 1. Given odd number y.

Step 2. Find biggest integer s such that y−1=2^{s}·ν, where s and ν are positive integers and t is odd.

Step 3. Generate random α which is in a range of [2, y−2].

Step 4. If α^{ν}≢1 mod y and α²^{^{r}}^{ν}−1 mod y for all 0≤r≤s−1, y is a composite number.

Step 5. Repeat step 3 to step 4 for a couple of times, if no judgment that y is composite is given, output y as a probabilistic prime number.

Rabin-Miller primality test is probabilistic, which means if y is prime, it will never be determined as composite; if y is composite, there is a small chance that it will be determined as prime number. As observed, by repeating the above test with different choices of random a in step 3, the chance that a composite number be determined as prime will be decreased exponentially.

It is note that the RSA key pair is stored on separate hardware storage. Such secure hardware storage increases the cost of the mobile device and limits the use of space within the enclosure of a mobile device. Hence, those skilled in the art are striving to improve the storage of RSA key pair.

### SUMMARY

The above and other problems are solved and an advance in the art is made by systems and methods provided by embodiments in accordance with the invention. A first advantage of embodiments of systems and methods in accordance with the invention is that the systems and methods are based on a deterministic derivation function that takes a seed value and a given bit length to outputs a prime number with the given bit length. A second advantage of embodiments of systems and methods in accordance with the invention is that the prime number generated is based on a deterministic derivation function, the prime numbers can be recovered. Hence, simplifying provisioning and management of device certificates. A third advantage of embodiments of systems and methods in accordance with the invention is that systems and methods is software implemented. Hence, this can be easily implemented on existing devices.

The above advantages are provided by embodiments of a system and a method of generating prime numbers. The system comprises a pseudorandom number generator (PRNG) module and a prime number generator (PNG) module. The PRNG module is configured to: receive a request from the PNG module, the request containing a bit length of the pseudorandom number required; generate the required bit length of pseudorandom number; transmit a response containing the generated bit length of pseudorandom numbers to the PNG module. The PNG module is configured to: transmit the request containing the bit length of the pseudorandom numbers required; receive the response from the PRNG module; assign the pseudorandom numbers in the response to form raw data PPP; set a least significant bit (LSB) and most significant bit (MSB) of PPP as 1 to obtain a first odd number denoted as PP; and execute an algorithm to determine a first big prime number starting from odd number PP.

In accordance with an embodiment of this application, the PRNG module comprises a PRNG to generate the required bit length of pseudorandom number, the PRNG takes an input seed value from a root key from a source and a given bit length. In accordance with an embodiment of this application, the root key is obtained from a device hardware unique key and the given bit length is 1024 bits.

In accordance with an embodiment of this application, the step to execute the algorithm to determine the first prime number starting from odd number PP comprises the PNG module to: calculate a product of m number of small prime number, prod=Πᵢ₌₀^{m-1}pᵢ, where pᵢ is the i-th smallest prime number; initialise a first counter, d1, and a second counter, d2, as zero; calculate the greatest common divisor of x and prod, where x is PP, with the following function, t=GCD(x,prod); determine if t=1; execute Rabin-Miller primality test on x in response to t=1; determine x as the first prime number in response to x passing the Rabin-Miller primality test; and storing d1 and d2 in a memory.

In accordance with an embodiment of this application, the step to execute the algorithm to determine the first prime number starting from odd number PP further comprises the PNG module to: set Next function, x=Next(x, step1) and d1=d1+1 and repeat from the step to calculate the greatest common divisor of x and prod in response to t≠1. In accordance with an embodiment of this embodiment, the Next function, x=Next(x,step1) is one of addition (PP=PP+step1), XOR (PP=PP⊕step1) and modular addition (PP≡PP+step1 mod N). Further, the step1 is 2.

In accordance with an embodiment of this application, the step to execute the algorithm to determine the first prime number starting from odd number PP further comprises the PNG module to: update x=x+prod and d2=d2+1 and repeat the Rabin-Miller primality test on x in response to x failing the Rabin-Miller primality test.

In accordance with an embodiment of this application, the step to execute the Rabin-Miller primality test comprises the PNG module to: determine a biggest integer s such that x−1=2^{s}·ν, where ν is a positive odd integer; transmit another request to the PRNG module containing a bit length of the pseudorandom numbers required; receive the required pseudorandom number from the PRNG module; assign the required pseudorandom numbers to form a first random number α′; select a second random number α within a range of 2 and x−2. In accordance with an embodiment of this embodiment, the second random number α is selected with the following expression, α=2+(α′ mod (x−3)). In accordance with an embodiment of this embodiment, the step to determine if x is a composite number comprises the PNG module to: determine x is a composite number if α^{ν}≢1 mod x and a²^{^{r}}^{ν}≢−1 mod x for all 0≤r≤s−1.

In accordance with an embodiment of this application, the PNG module is further configured to recover the first prime number in the following manner. The PNG module retrieves d1 and d2 from the memory and determines the first prime number, P, with the following expression, P=PP+(step1×d1)+(prod×d2).

In accordance with an embodiment of this application, the step to execute the algorithm to determine the first prime number starting from odd number PP comprises the PNG module to: calculate rxᵢ≡x mod pᵢ for 0≤i<m, where pᵢ is the i-th smallest prime number, rxᵢ is a single-precision word and x=PP; initialise a counter, d, as zero; determine if rxᵢ+2d can be divided by any pᵢ for 0≤i<m; execute Rabin-Miller primality test on x+2d in response to rxᵢ+2d being not dividable by all pᵢ, for 0≤i<m; determine x+2d as the first prime number in response to x+2d passing the Rabin-Miller primality test; and storing d in a memory.

In accordance with an embodiment of this application, the step to execute the algorithm to determine the first prime number starting from odd number PP further comprises the PNG module to: set d=d+1 and repeat from the step to determine if rxᵢ+2d can be divided by pᵢ in response to rxᵢ+2d being dividable by any pᵢ for 0≤i<m.

In accordance with an embodiment of this application, the step to execute the algorithm to determine the first prime number starting from odd number PP further comprises the PNG module to: update d=d+1 and repeat from the step to determine if rxᵢ+2d can be divided by pᵢ in response to x+2d failing the Rabin-Miller primality test.

In accordance with an embodiment of this application, the step to execute the Rabin-Miller primality test comprises the PNG module to: determine a biggest integer s such that (x+2d)−1=2^{s}·ν, where ν is a positive odd integer; transmit another request to the PRNG module containing a bit length of the pseudorandom numbers required; receive the required pseudorandom number from the PRNG module; assign the required pseudorandom numbers to form a first random number α′; select a second random number α within a range of 2 and (x+2d)−2. In accordance with an embodiment of this embodiment, the second random number α is selected with the following expression, α=2+(α′ mod (x+2d−3)). In accordance with an embodiment of this embodiment, the step to determine if x+2d is a composite number comprises the PNG module to: determine x+2d is a composite number if α^{ν}≢1 mod (x+2d) and α²^{^{r}}^{ν}≢1 mod (x+2d) for all 0≤r≤s−1.

In accordance with an embodiment of this application, the PNG module is further configured to recover the first prime number in the following manner. The PNG module retrieves d from the memory and determines the first prime number, P, with the following expression, P=PP+(2×d).

In accordance with an embodiment of this application, the PNG module is further configured to: assign the pseudorandom numbers in the response to form another raw data QQQ; set a least significant bit (LSB) and most significant bit (MSB) of QQQ as 1 to obtain a second odd number denoted as QQ; and execute the algorithm to determine a second big prime number starting from the second odd number QQ.

In accordance with another aspect of the application, a method for generating a prime number between a pseudorandom number generator (PRNG) module and a prime number generator (PNG) module is provided in the following manner. The method comprises: the prime number generator (PNG) module to: receiving a request from the PNG module, the request containing a bit length of the pseudorandom number required; generating the required bit length of pseudorandom number; transmitting a response containing the generated bit length of pseudorandom numbers to the PNG module; and the PNG module to: transmitting the request containing the bit length of the pseudorandom numbers required; receiving the response from the PRNG module; assigning the pseudorandom numbers in the response to form raw data PPP; setting a least significant bit (LSB) and most significant bit (MSB) of PPP as 1 to obtain a first big odd number denoted as PP; and executing an algorithm to determine a first big prime number starting from odd number PP.

In accordance with an embodiment of this application, the PRNG generates the required bit length of pseudorandom number based on an input seed value from a root key from a source and a given bit length. In accordance with an embodiment of this embodiment, the root key is obtained from a device hardware unique key and the given bit length is 1024 bits.

In accordance with an embodiment of this application, the step of executing the algorithm to determine the first prime number starting from odd number PP comprises: calculating a product of m number of small prime number, prod=Πᵢ₌₀^{m-1}pᵢ, where pᵢ is the i-th smallest prime number; initialising a first counter, d1, and a second counter, d2, as zero; calculating the greatest common divisor of x and prod, where x is PP, with the following function, t=GCD (x, prod); determining if t=1; executing Rabin-Miller primality test on x in response to t=1; determining x as the first prime number in response to x passing the Rabin-Miller primality test; and storing d1 and d2 in a memory.

In accordance with an embodiment of this application, the step of executing the algorithm to determine the first prime number starting from odd number PP further comprises: setting Next function, x=Next(x,step1) and d1=d1+1 and repeats from the step of calculating the greatest common divisor of x and prod in response to t≠1. In accordance with an embodiment of this embodiment, the Next function, x=Next(x,step1) is one of addition (PP=PP+step1), XOR (PP=PP⊕step1) and modular addition (PP≡PP+step1 mod N). Preferably, step1 is 2.

In accordance with an embodiment of this application, the step of executing the algorithm to determine the first prime number starting from odd number PP further comprises: updating x=x+prod and d2=d2+1 and repeating the Rabin-Miller primality test on x in response to x failing the Rabin-Miller primality test.

In accordance with an embodiment of this application, the step of executing the Rabin-Miller primality test comprises: determining a biggest integer s such that x−1=2^{s}·ν, where ν is a positive odd integer; transmitting another request to the PRNG module containing a bit length of the pseudorandom numbers required; receiving the required pseudorandom number from the PRNG module; assigning the required pseudorandom numbers to form a first random number α′; selecting a second random number α within a range of 2 and x−2. In accordance with an embodiment of this embodiment, the second random number a is selected with the following expression, α=2+(α′ mod (x−3)). In accordance with an embodiment of this embodiment, the step of determining if x is a composite number comprises: determining x is a composite number if α^{ν}≢1 mod x and a²^{^{r}}^{ν}≢−1 mod x for all 0≤r≤s−1.

In accordance with an embodiment of this application, the PNG module is configured to recovering the first prime number in the following manner. The method retrieves d1 and d2 from the memory and determines the first prime number, P, with the following expression, P=PP+(step1×d1)+(prod×d2).

In accordance with an embodiment of this application, the step of executing the algorithm to determine the first prime number starting from odd number PP comprises: calculating rxᵢ≡x mod pᵢ for 0≤i<m, where pᵢ is the i-th smallest prime number, rxᵢ is a single-precision word and x=PP; initialising a counter, d, as zero; determining if rxᵢ+2d can be divided by any pᵢ for 0≤i<m; executing Rabin-Miller primality test on x+2d in response to rxᵢ+2d not being dividable by all pᵢ for 0≤i<m; determining x+2d as the first prime number in response to x+2d passing the Rabin-Miller primality test; and storing d in a memory.

In accordance with an embodiment of this application, the step of executing the algorithm to determine the first prime number starting from odd number PP further comprises: setting d=d+1 and repeating from the step of determining if rxᵢ+2d can be divided by pᵢ in response to rxᵢ+2d being dividable by any pᵢ for 0≤i<m.

In accordance with an embodiment of this application, the step of executing the algorithm to determine the first prime number starting from odd number PP further comprises: updating d=d+1 and repeating from the step of determining if rxᵢ+2d can be divided by pᵢ in response to x+2d failing the Rabin-Miller primality test.

In accordance with an embodiment of this application, the step of executing the Rabin-Miller primality test comprises: determining a biggest integer s such that (x+2d)−1=2^{s}·ν, where ν is a positive odd integer; transmitting another request to the PRNG module containing a bit length of the pseudorandom numbers required; receiving the required pseudorandom number from the PRNG module; assigning the required pseudorandom numbers to form a first random number α′; selecting a second random number α within a range of 2 and (x+2d)−2. In accordance with an embodiment of this embodiment, the second random number a is selected with the following expression, α=2+(α′ mod (x+2d)−3)). In accordance with an embodiment of this embodiment, the step of determining if x+2d is a composite number comprises: determining x+2d is a composite number if α^{ν}≢1 mod (x+2d) and a²^{^{r}}^{ν}≢1 mod (x+2d) for all 0≤r≤s−1.

In accordance with an embodiment of this application, the method further comprises the PNG module to recovering the first prime number in the following manner. The method retrieves d from the memory and determines the first prime number, P, with the following expression, P=PP+(2×d).

In accordance with an embodiment of this application, the method further comprises the PNG module to: assigning the pseudorandom numbers in the response to form another raw data QQQ; setting a least significant bit (LSB) and most significant bit (MSB) of QQQ as 1 to obtain a second odd number denoted as QQ; and executing the algorithm to determine a second big prime number starting from the second odd number QQ.

### BRIEF DESCRIPTION OF THE DRAWINGS

The above advantages and features in accordance with this invention are described in the following detailed description and are shown in the following drawings:

FIG. 1 illustrating a system 100 for performing the proposed algorithm to determine prime numbers in accordance with this application;

FIG. 2 illustrating a timing diagram 100 of the information flow between the pseudorandom number generator module and a prime number generator module in accordance with this application;

FIG. 3 illustrating a process 300 performed by a pseudorandom number generator module to generate and transmit pseudorandom number in accordance with this application;

FIG. 4 illustrating an example of a pseudorandom number generator for generating pseudorandom numbers in accordance with this application;

FIG. 5 illustrating a process 500 performed by the prime number generator module for determining a prime number in accordance with this application;

FIG. 6 illustrating a first process 600 performed by the prime number generator module executing a first algorithm to determine the first prime number starting from odd number PP in accordance with this application;

FIG. 7 illustrating a first process 700 performed by the prime number generator module executing a second algorithm to determine the first prime number starting from odd number PP in accordance with this application;

FIG. 8 illustrating a process 800 performed by the PNG module 140 executing the Rabin-Miller primality test in accordance with this application;

FIG. 9 illustrating an overall process 900 for generating and recovering the two prime numbers for generating a RSA key pairs in accordance with this application;

FIG. 10 illustrating an example of an application of system 100 in accordance with this application.

### DESCRIPTION OF EMBODIMENTS

This application relates to a method and system for obtaining two prime numbers for generating a pair of keys. Particularly, the application relates to a method and system implementing a deterministic derivation function to obtain prime numbers.

In this application, it is proposed that the algorithm to be implemented is a deterministic derivation function that takes a seed value (usually a root key of 256 bits) and a given bit length, and outputs a prime number with the given bit length. When the same input values are provided to this algorithm, the output prime number is required to be always the same. The proposed algorithm consists of two parts:

First, the primes are generated from RK, where deterministic procedure is used to find primes and fast recovery information. The fast recovery information is offset value allowing quick recovery.

Secondly, primes are recovered by using RK and recovery information. This may happen in different device during the first part. For example powerful server may pre-compute fast recovery values for P and Q. Devices with less computation power can quickly recover P and Q from recovery values.

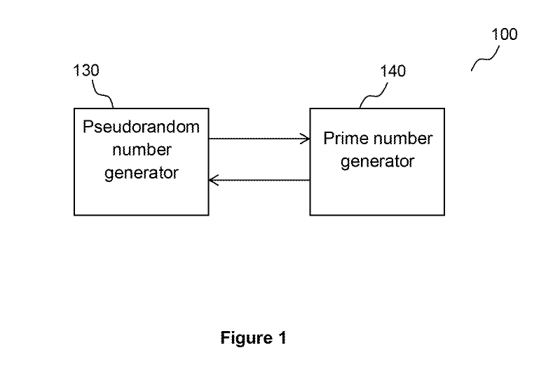

FIG. 1 illustrates a system 100 for performing the proposed algorithm. The system 100 comprises a pseudorandom number generator (PRNG) module 130 and a prime number generator (PNG) module 140. In operation, the PNG module 140 sends a request for required bit length of pseudorandom number to the PRNG module 130. In response to the request, the PRNG module 130 generates pseudorandom number and sends the required bit length of pseudorandom number to the PNG module 130. Upon receipt of the pseudorandom number, the PNG module 140 executes an algorithm to determine 2 large prime numbers, namely, P and Q. The use of two separate modules is such that the actual process of generating the pseudorandom number by the PRNG module 130 is not known to the PNG module 140. Further details of the processes performed by the PRNG module 130 and PNG module 140 would be described below.

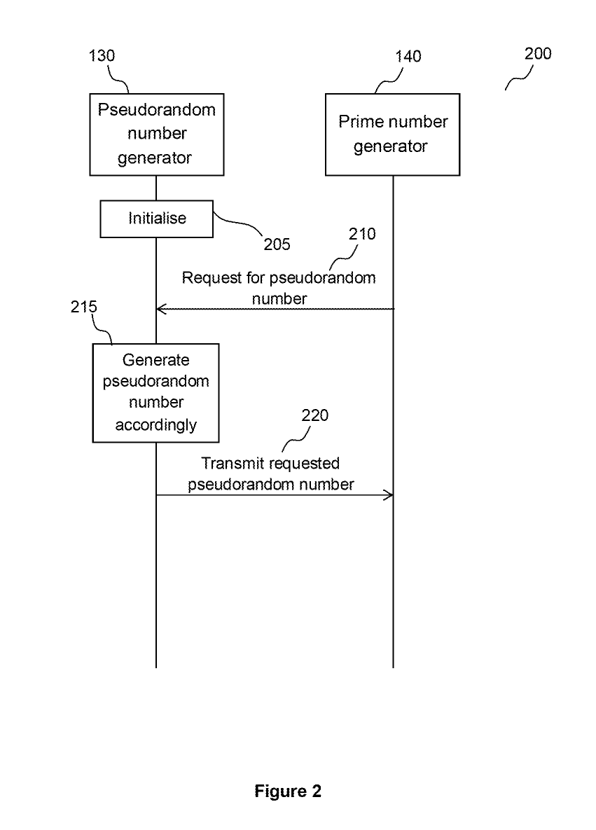

FIG. 2 illustrates a timing diagram 200 of the information flow between the PRNG module 130 and the PNG module 140. Timing diagram 200 begins with step 205 where the PRNG module 130 initialises.

In step 210, the PNG module 140 generates and transmits a request for bit length of pseudorandom number to the PRNG module 130. In response to receiving the request, the PRNG module 130 generates the required bit length of pseudorandom number in step 215.

In step 220, the PRNG module 130 transmits the requested bit length of pseudorandom number to the prime number generator module 140. In response to receiving the requested bit length of pseudorandom number, the PNG module 140 generates the prime numbers. Steps 210, 215 and 220 are repeated as and when the PNG module 140 request for pseudorandom number. Further details of the processes performed by each of the PRNG module 130 and PNG module 140 would be described as follows.

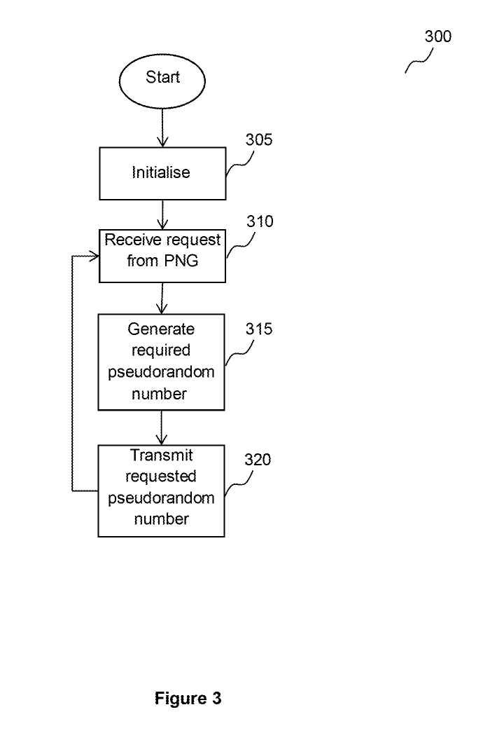

FIG. 3 illustrates a process 300 performed by the PRNG module 130 to generating and transmitting pseudorandom number to the PNG module 140 in accordance with this application.

Process 300 begins with step 305 where the PRNG 134 is initialised. The PRNG module 130 then receives a request from the PNG module 140 in step 310. The request contains the bit length of the pseudorandom number required.

In response to receiving the request, the PRNG module 130 generates, via the PRNG 134, the required bit length of pseudorandom number in step 315.

In step 320, the PRNG module 130 transmits the generated bit length of pseudorandom numbers to the PNG module 140. Steps 310-320 are repeated as and when the PRNG module 130 receives a request from the PNG module 140 and will repeat from step 305 when the PRNG 134 is being requested to be initialised.

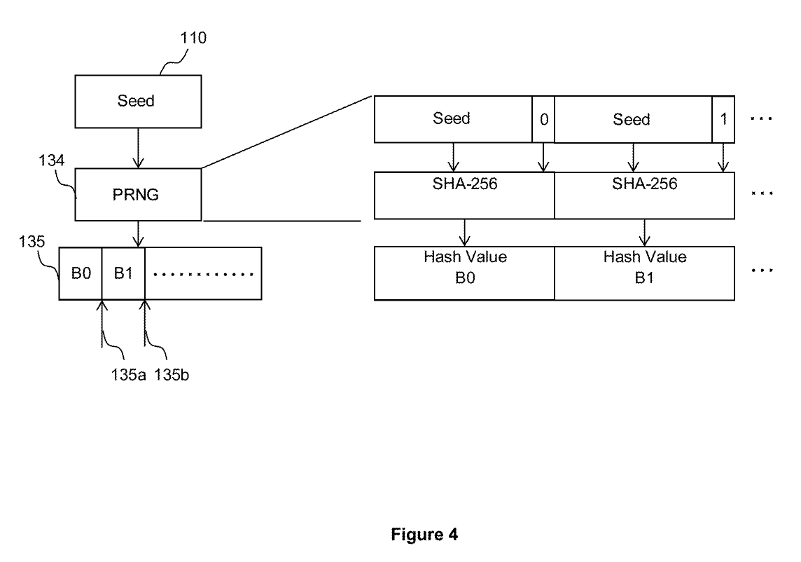

Essentially, the PRNG module 130 comprises a PRNG 134 for generating pseudorandom number. PRNG takes an input seed value (usually of fixed length) and output a pseudo-random bit stream of arbitrary length. The output pseudo-random bit stream will always be the same if the input seed value is used. FIG. 4 illustrates an example of a PRNG 134 where the seed value 110 is based on the root key of 256 bits from a mobile device and a given bit length, i.e. Seed=(RK, bit length). The given bit length determines the bit length of the output of the PRNG 134.

With the seed value 110, the PRNG 134 generates pseudorandom number 135, B0, B1, B2, . . . . On the right of the PRNG 134 shows the expanded view of the PRNG 134 taking the seed value 110 and block-wise counter starting from zero and running through a hash function, SHA-256 to generate the pseudo-random stream, which is deterministic and can be of arbitrary length. The output of the PRNG 134 as illustrated in FIG. 4 can be expressed as follows, Bi=SHA-256(Seed,i). Assuming the bit length is 256-bit, the block size of each block of pseudorandom number 135 is 256-bit. If the bit length is 1-bit, the block size of each block of pseudorandom number 135 is 1-bit. The choice of the bit length is left to those skilled in the art.

The pointers 135a and 135b are to illustrate that assuming the bit length requested by the PNG module 140 is 256 bits, the PRNG module 130 would generate B0 with the pointer ending at 135a and B0 would be sent to the PNG module 140. If the next request from the PNG module 140 is 256 bits, the PRNG module 130 would generate B1 with the pointer ending at 135b and B1 would be sent to the PNG module 130. In another example, assuming the bit length requested by the PNG module 140 is 1000 bits, the PRNG module 130 would generate B0, B1, B2 and B3 with the pointer ending at the end of B3 and the first 1000 bits from B0-B3 would be sent to the PNG module 140 with the remaining 24 bits of data discarded. If the next request from the PNG module 140 is 500 bits, the PRNG module 130 would generate B4 and B5 with the pointer ending at the end of B5 and the first 500 bits from B4-B5 would be sent to the PNG module 140 with the remaining 12 bits of data discarded.

Briefly, the PRNG module 130 would generate blocks of pseudorandom number at least until the required bit length of pseudorandom number is available. The PRNG 134 would pause after generating the blocks of pseudorandom number and wait for the next request from the PNG module 140 while the PRNG module 130 transmits the required bit length of pseudorandom number to the PNG module 140.

One skilled in the art will recognise that other choices of PRNG may be implemented without departing from this application. For example, NIST (National Institute of Standards and Technology of USA) has DRBG standards such as CTR_DRBG, HASH_DRBG and HMAC_DRBG, whose specification can be found in NIST Special Publication 800-90A.

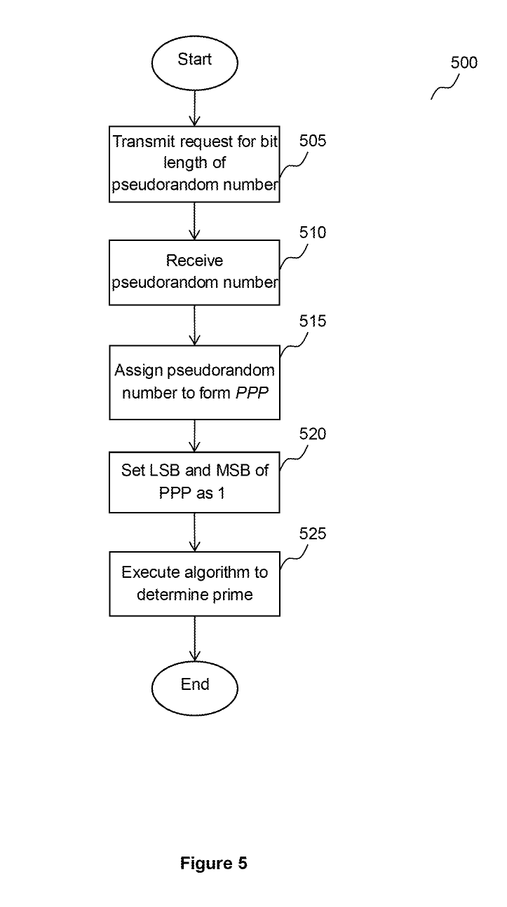

FIG. 5 illustrates a process 500 performed by the PNG module 140 for determining a prime number in accordance with this application. Process 500 begins with step 505 where the PNG module 140 transmits a request containing the bit length of the pseudorandom numbers required. For this illustration, we would be using 1024 bits for determining a prime number, since the RSA key pair uses 2048 bits, i.e. 1024 bits for each of P and Q.

In step 510, the PNG module 140 receives the bit length of 1024 bits of pseudorandom number from the PRNG module 130.

In response to receiving the pseudorandom number from the PRNG module 130, the PNG module 140 assigns the pseudorandom numbers to form raw data PPP which is 1024 bits in step 515.

In step 520, the PNG module 140 sets the least significant bit (LSB) and most significant bit (MSB) of PPP 1 and obtains a big odd number denoted as PP. The big odd number is for determining the big prime number, P.

In step 525, the PNG module 140 executes an algorithm to determine the first prime number starting from odd number PP. In short, the algorithm receives the odd number PP as an input and returns an output which is being assigned as the big prime number, P. Briefly, the algorithm comprises checking whether PP has small a prime factor. If PP has a small prime factor (e.g. pᵢ|PP), the algorithm repeats the check for the next prime, i.e. set PP=Next(PP, step). The Next function (PP=Next(PP, step)) can be addition (PP=PP+step), XOR (PP=PP⊕step) and modular addition (PP⊕PP+step mod N) etc. One skilled in the art will recognise that any other types of function may be chosen as the Next function, as long as we can repeatedly apply it to the value of PP to enumerate different possible values of PP.

If PP does not have a small prime factor, the algorithm runs Rabin-Miller primality test on PP with the random number (a). It is important to note that random number (a) is requested from the PRNG module 130. As mentioned above, the more iteration used in Rabin-Miller primality test increases the confidence in the primality of the output probabilistic prime number, but requires more computing power and time. Hence, there will be trade-offs between having a good primality and performance. If the PP does not pass Rabin-Miller primality test, the algorithm repeats from the check for the next prime, i.e. set PP=Next(PP, step). If the PP passes Rabin-Miller primality test, the algorithm determines the PP as the prime number P. Further details on the algorithm to determine the next prime number would be described below.

Process 500 illustrates the process of generating one big prime number. In order to determine two prime numbers for generating RSA key pair, process 500 may be repeated to determine the second prime number, Q. Alternatively, process 500 may be modified such that instead of requesting a bit length of pseudorandom number to form a big odd number PP in steps 505-520, process 500 may request for a bit length of pseudorandom number to form two big odd numbers PP and QQ. Thereafter, step 525 may be executed twice either sequentially or concurrently to determine two big prime numbers, P and Q.

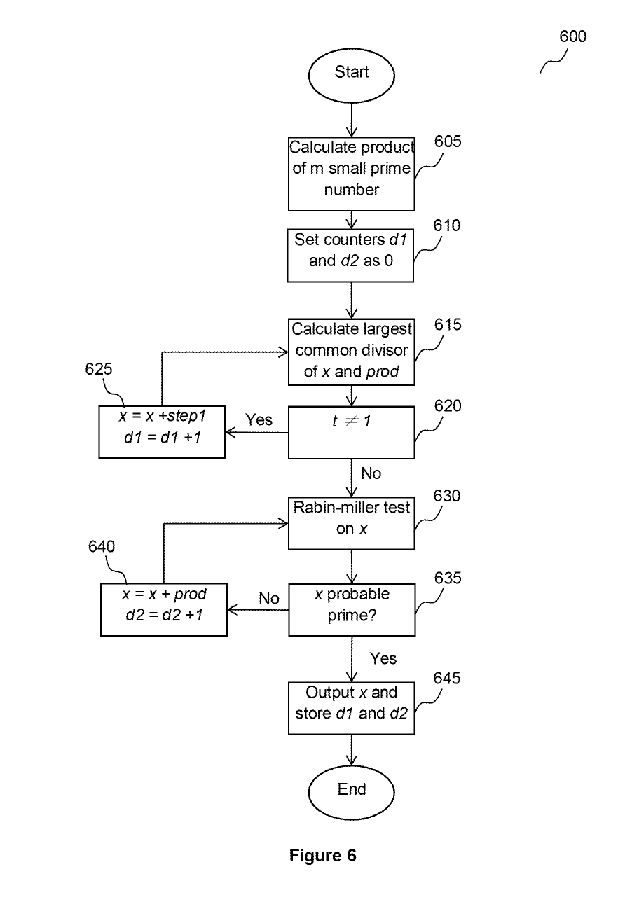

FIG. 6 illustrates a first process 600 performed by the PNG module 140 executing a first algorithm to determine a prime number starting from odd number PP. Let x be the input value from step 525 of process 500, i.e. x=PP. Process 600 begins with step 605 by calculating the product of m number of small prime number, prod=Πᵢ₌₀^{m-1}pᵢ, where pᵢ is the i-th smallest prime number, i.e. 2. We choose the smallest prime numbers as {pᵢ}_{0≤i<m}={2, 3, 5, 7, 11, 13 . . . }. When we are deriving a 1024-bit prime number, the maximum value of m is 130. Since if m>130, prod becomes more than 1024 bits, the filter of small prime factor no longer works. It means that we can filter at most 130 small prime factors using this technique.

In step 610, process 600 initialises two counters as zero, namely, d1=0 and d2=0. Process 600 then calculates the greatest common divisor of x and prod in step 615 with the following function, t=GCD(x,prod).

In step 620, if t≠1, it means t is a factor of x (t|x) and x is not a prime number. Hence, process 600 proceeds to step 625. If t=1, it means that x does not have factors of small primes any more: GCD(x,prod)=1, which make it a good candidate for primality test. In short, if t=1, x may be a prime number and process 600 proceeds to step 630.

In step 625, process 600 sets x=x+step1 and d1=d1+1 and repeats from step 615. Preferably, step1=2. The next function (x=x+step1) can be replaced with XOR function (x=x⊕step1) or modular addition (x≢x+step1 mod N) etc.

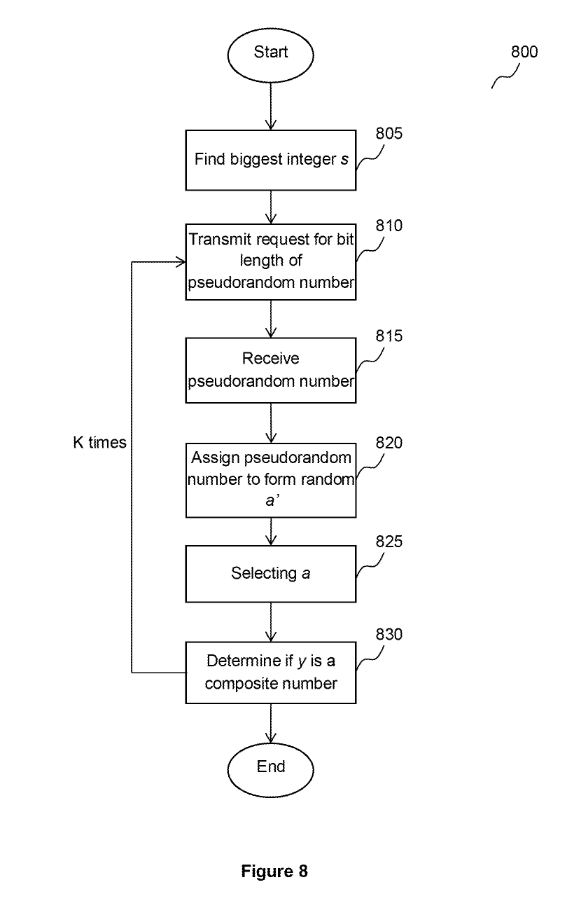

In step 630, process 600 runs Rabin-Miller primality test on x. Further details on the Rabin-Miller primality test would be described below with reference to FIG. 8.

In step 635, if the Rabin-Miller test fails on x, process 600 proceeds to step 640. If x passes the Rabin-Miller test, process 600 proceeds to step 645.

In step 640, process 600 updates x=x+prod, and d2=d2+1 and repeats from step 630. It is observed that GCD (x+prod, prod)=GCD (x, prod)=1. The updated value of x doesn't have factor of small primes either, which makes it also a good candidate. If x pass the Rabin-Miller test, process 600 proceeds to step 645 and outputs the value x and stores d1 and d2 as offset values. The offset values d1 and d2 are stored on the memory for recovering the prime number.

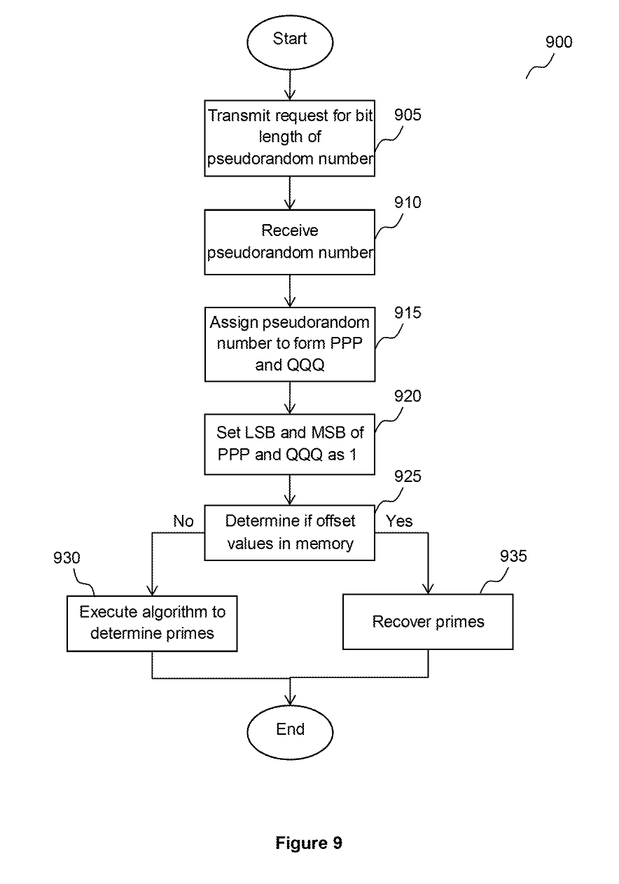

Process 600 may be repeated to determine another prime number, Q. Process 600 may be executed twice either sequentially or concurrently to determine both prime numbers, P and Q. Further details on generating two prime numbers would be described below with reference to FIG. 9.

In order to recover the 2 prime numbers, step 525 of process 500 is replaced with a recovery process. In short, in order to recover the two prime numbers, P and Q, the recovery process goes through steps 505-520 to obtain two big odd numbers PP and QQ and thereafter executes a recovery process where the PNG module 140 retrieves the offset values d1, d2 of both P (d₁^{P} and d₂^{P}) and Q (d₁^{Q} and d₂^{Q}) from the memory and determines P and Q, with the following functions:

P=PP+(step1×d₁^{P})+(prod×d₂^{P})

Q=QQ+(step1×d₁^{Q})+(prod×d₂^{Q})

Where step1 is 2; prod is the product of m number of small prime number, prod=Πᵢ₌₀^{m-1}pᵢ, where pᵢ is the i-th smallest prime number, i.e. p₀=2, p₁=3, p₂=5, . . . .

As observed in the recovery process, the prime number P can be easily recovered by the following function, P=PP+(2×d1)+(prod·d2) without the time-consuming primality testing algorithm. Hence, recovery process runs much faster than the generation process.

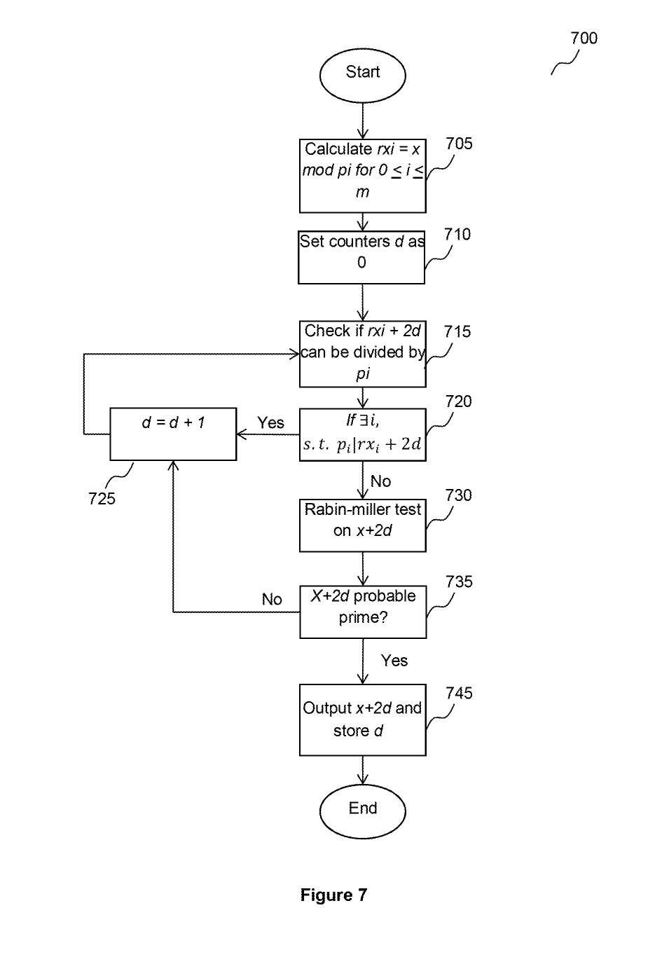

FIG. 7 illustrates a second process 700 performed by the PNG module 140 executing a second algorithm to determine the first prime number starting from odd number PP. Let x be the input value from step 525 of process 500, i.e. x=PP. Process 700 begins with step 705 by calculating rxᵢ≡x mod pᵢ for 0≤i<m, where pᵢ is the i-th smallest prime number and rxᵢ is a single-precision word (usually 32-bit or 64-bit).

In step 710, process 700 sets counter d=0.

In step 715, process check if rxᵢ+2d can be divided by any pᵢ for 0≤i<m.

In step 720, if ∃i, s. t. pᵢ|rxᵢ+2d, process 700 proceeds to step 730 and runs the Rabin-Miller primality test. In other words, if for all iϵ[0, m−1], rxᵢ+2d cannot be divided by pᵢ, process 700 proceeds to step 730. Otherwise, process 700 proceeds to step 725 and sets d=d+1. In step 720, if pᵢ|rxᵢ+2d, we know that x+2d≡rxᵢ+2d≡0 mod pᵢ, x+2d is not prime. Checking if pᵢ|rx+2d only cost a single-precision remainder operation, which is much more efficient than remainder calculation on the big number x+2d. This technique allows us to efficiently check m number of small prime factors.

After step 725, process 700 repeats from step 715.

In step 730, process 700 runs the Rabin-Miller primality test on x+2d. Further details on the Rabin-Miller primality test would be described below with reference to FIG. 8.

In step 735, if x+2d does not pass Rabin-Miller test, process 700 proceeds to step 725. Otherwise, process 700 proceeds to step 745 and outputs x+2d a big prime number and stores d as offset value. The offset value d is stored on the memory for recovering the big prime number.

Process 700 may be repeated to determine another prime number, Q. Process 700 may be executed twice either sequentially or concurrently to determine both prime numbers, P and Q. Further details on generating two prime numbers would be described below with reference to FIG. 9.

In order to recover the 2 prime numbers, step 525 of process 500 is replaced with a recovery process. In short, in order to recover the two prime numbers, P and Q, the recovery process goes through steps 505-520 to obtain two big odd numbers PP and QQ and thereafter execute a recovery step where the PNG module 140 retrieves the offset value d of both P (d^{P}) and Q (d^{Q}) from the memory and determines P and Q, with the following functions:

P=PP+(2×d^{P})

Q=QQ+(2×d^{Q})

FIG. 8 illustrates a process 800 performed by the PNG module 140 executing the Rabin-Miller primality test in step 630 of process 600 and step 730 of process 700. Let y be the odd number to be tested. In other words, y=x in relation to step 630 in process 600 and y=x+2d in relation to step 730 in process 700. Process 800 begins with step 805 where the PNG module 140 determines the biggest integer s such that y−1=2^{s}·ν, where ν is a positive odd integer.

In step 810, the PNG module 140 transmits a request containing the bit length of the pseudorandom numbers required. For purpose of this illustration, we would be using 1024 bits.

In step 815, the PNG module 140 receives the bit length of 1024 bits of pseudorandom number from the PRNG module 130.

In response to receiving the pseudorandom number from the PRNG module 130, the PNG module 140 assigns the pseudorandom numbers to form a first random number α′ in step 820.

In step 825, the PNG module 140 selects a second random number α which is in a range of [2, y−2] with the following expression, α=2+(α′ mod (y−3)). One skilled in the art will recognise that other methods of selecting the second random number a may be implemented without departing from the application.

In step 830, the PNG module 140 determines if y is a composite number. In particular, if α^{ν}≢1 mod y and α²^{^{r}}^{ν}≢−1 mod y for all 0≤r≤s−1, y is a composite number and y is not a prime.

Steps 810-830 are repeated for K times with different random number a and if no judgment that y is composite is given, y is output as a probabilistic prime number.

Rabin-Miller primality test is probabilistic, which means if y is prime, it will never be determined as composite; if y is composite, there is a small chance that it will be determined as prime number. As observed, by repeating the above test with different choices of random number a in steps 810-825, the chance that a composite number be determined as prime will be decreased exponentially.

FIG. 9 illustrates an overall process 900 for determining two prime numbers for generating a RSA key pairs from a given root key RK and bit length. Process 900 begins with step 905 where the PNG module 140 transmits a request containing the bit length of the pseudorandom numbers required. For this illustration, we would be using 2048 bits for determining two prime numbers, since the RSA key pair uses 2048 bits, i.e. 1024 bits for each of P and Q.

In step 910, the PNG module 140 receives the bit length of 2048 bits of pseudorandom number from the PRNG module 130.

In response to receiving the pseudorandom number from the PRNG module 130, the PNG module 140 assigns the first 1024 bits of pseudorandom numbers to form a first raw data PPP and the subsequent 1024 bits of pseudorandom numbers to form a second raw data QQQ.

In step 920, the PNG module 140 sets the least significant bit (LSB) and most significant bit (MSB) of PPP and QQQ as 1 and obtains a first big odd number denoted as PP and a second big odd number denoted as QQ. The first big odd number is for determining the first big prime number, P while the second big odd number is for determining the second big prime number, Q.

In step 925, the PNG module 140 determines whether the offset values are stored in the memory. If the offset values are stored on the memory, process 900 proceeds to step 935 to recover the prime numbers based on the offset values. If the offset values are not stored on the memory, process 900 proceeds to step 930 to execute the algorithm to determine the prime numbers.

In step 930, the PNG module 14 executes the algorithm to determine the prime numbers according to either process 600 or process 700. In this regard, either process 600 or process 700 is selected to determine the two prime numbers. Alternatively, it is also possible to execute process 600 to determine the first prime number and process 700 to determine the second prime number, and vice versa, without departing from the application.

In step 935, the recovery process is dependent on the selection of process 600 or process 700 for generating the prime numbers, P and Q.

The two prime numbers, P and Q are then used for generating the RSA key pairs. The details of generating the RSA key pairs are well known and have been described above in the summary of prior art.

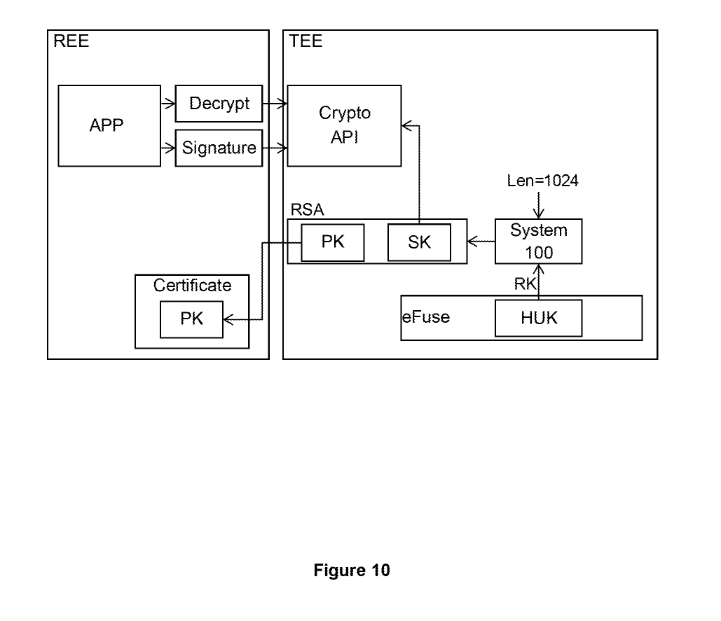

FIG. 10 illustrates an example of an application of this application. The processes performed by the system 100 is used to generate and recover device RSA key pairs using the device hardware unique key HUK as the seed value. This only requires to store 256-bit root key, instead of 2048-bit RSA key pairs. Root Key is typically stored in One Time Programmable (OTP) memory using eFuse technology. This kind of memory is typically very limited and expensive, therefore it is not reasonable to store directly large data such as RSA key into OTP memory. In other words, system 100 is used instead of storing 2048-bit RSA key pairs. Further, as the processes performed by the system 100 is software implemented, older version of devices which only have symmetric device key can also benefit from this as it is only required to upgrade the software of the devices.

It is also possible to obtain unique RSA key pair by replacing RK with the following function, f(RK, seed), where f is one-way key derivation function (KDF). For example f is KDF1-SHA256. This allows us to support derivation of multiple keys.

Beneficially, prime generation needs to be done only once and later, much faster recovery is needed. Since the system 100 uses PRNG 134, the two prime numbers are be reproduced.

The system 100 is also applicable in resource constrained devices such as sensors and other IoT devices, because they can use pre-computed offset values for prime recovery.

The above is a description of embodiments of a method and system of implementing a deterministic derivation function to obtain two large prime numbers in order to generate a pair of keys. It is foreseeable that those skilled in the art can and will design alternative method and system based on this application that infringe upon this invention as set forth in the following claims.

What is claimed is:

1. A system for generating a prime number comprising:
a pseudorandom number generator (PRNG) module and a prime number generator (PNG) module,
wherein the PNG module is configured to:
obtain a pseudorandom number from the PRNG module;
determine a big odd number denoted as PP according to the pseudorandom number;
execute primality test on PP; and
determine PP as the output prime number in response to PP passing the primality test.

2. The system according to claim 1 wherein the step performed by the PNG module of executing primality test on PP in response to PP has no small prime factor comprises:
determining the biggest integer s such that PP−1=2^{s}·ν, where ν is a positive odd integer;
obtaining another pseudorandom number from the PRNG module;
selecting a pseudorandom number α within a range of 2 and PP−2 according to the another pseudorandom number; and
determining PP is a composite number if α^{ν}≢1 mod PP and a²^{^{r}}^{ν}−1 mod PP for all 0≤r≤s−1.

3. The system according to claim 1, wherein the PRNG module comprises a PRNG to generate the required bit length of pseudorandom number, the PRNG takes an input seed value from a root key from a source and a given bit length.

4. The system according to claim 1, wherein the PRNG module is configured to:
receive a request from the PNG module, the request containing a bit length of the pseudorandom number required;
generate the required bit length of pseudorandom number; and
transmit a response containing the generated bit length of pseudorandom numbers to the PNG module.

5. The system according to claim 1, wherein the PNG module is further configured to:
run filter function on PP to check if it has any small prime factor;
the step of executing modified Rabin-Miller primality test on PP comprising:
execute modified Rabin-Miller primality test on PP in response to PP has no small prime factor.

6. A method for generating a prime number comprising:
obtaining a pseudorandom number;
determining a big odd number denoted as PP according to the pseudorandom number;
executing primality test on PP; and
determining PP as the output prime number in response to PP passing the primality test.

7. The method according to claim 6 wherein the step of executing primality test on PP in response to PP has no small prime factor comprising:
determining the biggest integer s such that PP−1=2^{s}·ν, where ν is a positive odd integer;
obtaining another pseudorandom number;
selecting a pseudorandom number a within a range of 2 and PP−2 according to the another pseudorandom number; and
determining PP is a composite number if α^{ν}≢1 mod PP and α²^{^{r}}^{ν}≢−1 mod PP for all 0≤r≤s−1.

8. The method according to claim 7, wherein a required bit length of pseudorandom number is generated by a seed value from a root key from a source and a given bit length.

9. The method according to claim 8, wherein the root key is obtained from a device hardware unique key and the given bit length is 1024 bits.

10. The method according to claim 6, the method further comprising:
running filter function on PP to check if it has any small prime factor;
the step of executing modified Rabin-Miller primality test on PP comprising:
executing modified Rabin-Miller primality test on PP in response to PP has no small prime factor.
